(19) United States
(12) Patent Application Publication
(10) Pub. No.: US 2024/0275240 A1
(43) Pub. Date: Aug. 15, 2024

(54) ROTOR ASSEMBLY FOR AN ELECTRIC MOTOR

(71) Applicant: MILWAUKEE ELECTRIC TOOL CORPORATION, Brookfield, WI (US)

(72) Inventors: Jacob N. Nemec, Waldo, WI (US); Dawid A. Bilski, Oak Creek, WI (US); Linnea Emerson, Lisbon, WI (US); Troy C. Thorson, Cedarburg, WI (US); Anthony E. Breitbach, Muskego, WI (US); Terry L. Timmons, Oconomowoc, WI (US); Brandon L. Yahr, Slinger, WI (US); Paul J. Grosskreuz, West Bend, WI (US); Russell M. Rapant, Menomonee Falls, WI (US)

(21) Appl. No.: 18/436,469

(22) Filed: Feb. 8, 2024

Related U.S. Application Data
(60) Provisional application No. 63/485,096, filed on Feb. 15, 2023.

(51) Int. Cl. H02K 9/06; H02K 7/14

(52) U.S. Cl. CPC H02K 9/06; H02K 7/145

(57) ABSTRACT

An electric motor comprising a stator and a rotor assembly at least partially received in the stator. The rotor assembly includes a rotor body, a fan, and a shaft. The rotor body includes a lamination stack which defines a central aperture. The fan is formed separately from the rotor body, and the fan is coupled to the rotor body by a torque coupling. The shaft includes an outer surface. The shaft is pressed into the central aperture of the lamination stack with the outer surface engaged with the central aperture by an interference fit.

### CROSS-REFERENCE TO RELATED APPLICATION

This application claims priority to co-pending U.S. Provisional Patent Application No. 63/485,096 filed Feb. 15, 2023, the entire content of which is incorporated herein by reference.

### FIELD OF THE INVENTION

The present invention relates to power tools, and more particularly to power tools including electric motors having fans.

### BACKGROUND OF THE INVENTION

Tools, such as power tools, can include an electric motor having a rotor assembly to rotate a shaft and generate a torque output. The rotor assembly may include a fan mechanically coupled to the rotor body to form the rotor assembly.

### SUMMARY OF THE INVENTION

The invention provides, in one aspect an electric motor comprising a stator and a rotor assembly at least partially received in the stator. The rotor assembly includes a rotor body, a fan, and a shaft. The rotor body includes a lamination stack which defines a central aperture. The fan is formed separately from the rotor body, and the fan is coupled to the rotor body by a torque coupling. The shaft includes an outer surface. The shaft is pressed into the central aperture of the lamination stack with the outer surface engaged with the central aperture by an interference fit.

The invention provides, in another aspect, an electric motor comprising a stator and a rotor assembly at least partially received in the stator. The rotor assembly includes a rotor body, a fan, a shaft, and a torque coupling. The rotor body includes a lamination stack which defines a central aperture. The fan is formed separately from the rotor body. The shaft includes an outer surface. The shaft is pressed into the central aperture of the lamination stack with the outer surface of the shaft engaged with the central aperture by an interference fit. The torque coupling couples the fan to the shaft.

Other aspects of the invention will become apparent by consideration of the detailed description and accompanying drawings.

### BRIEF DESCRIPTION OF THE DRAWINGS

FIG. 1 is an exploded view of a prior art rotor assembly for an electric motor.

FIG. 2A is a perspective view of a rotor assembly according to a first embodiment of the present invention.

FIG. 2B is a cross-sectional view of the rotor assembly of FIG. 2A taken along section line 2B-2B in FIG. 2A.

FIG. 2C is a cross-sectional view of the rotor assembly during ultrasonic welding of the rotor assembly.

FIG. 3A is a perspective view of a rotor assembly according to a second embodiment of the present invention.

FIG. 3B is a cross-sectional view of the rotor assembly of FIG. 3A taken along section line 3B-3B in FIG. 3A.

FIG. 3C is a perspective view of an impeller of the rotor assembly of FIG. 3A.

FIG. 4A is a perspective view of a rotor assembly according to a third embodiment of the present invention.

FIG. 4B is a cross-sectional view of the rotor assembly of FIG. 4A taken along section line 4B-4B in FIG. 4A.

FIG. 4C is a cross-sectional view of the rotor assembly of FIG. 4B taken along section line 4C-4C in FIG. 4B.

FIG. 5A is a perspective view of a rotor assembly according to a fourth embodiment of the present invention.

FIG. 5B is a cross-sectional view of the rotor assembly of FIG. 5A taken along section line 5B-5B in FIG. 5A.

FIG. 5C is a perspective view of an impeller of the rotor assembly of FIG. 5A.

FIG. 5D is a perspective view of a rotor body of the rotor assembly of FIG. 5A.

FIG. 6A is a perspective view of a rotor assembly according to a fifth embodiment of the present invention.

FIG. 6B is a cross-sectional view of the rotor assembly of FIG. 6A taken along section line 6B-6B in FIG. 6A.

FIG. 7A is a perspective view of a rotor assembly according to a sixth embodiment of the present invention.

FIG. 7B is a cross-sectional view of the of the rotor assembly of FIG. 7A taken along section line 7B-7B in FIG. 7A.

FIG. 7C is a cross-sectional view of a rotor body taken along section line 7B-7B in

FIG. 7A.

FIG. 7D is a perspective view of a rotor body pin prior to heat staking.

FIG. 7E is a perspective view of the rotor body pin after heat staking.

FIG. 8A is a perspective view of a rotor assembly according to a seventh embodiment of the present invention.

FIG. 8B is a cross-sectional view of the rotor assembly of FIG. 8A taken along section line 8B-8B in FIG. 8A.

FIG. 9A is a perspective view of a rotor assembly according to an eighth embodiment of the present invention.

FIG. 9B is a perspective view of the rotor assembly of FIG. 9A taken along section line 9B-9B in FIG. 9A.

FIG. 9C is a side view of a rotor shaft of the rotor assembly of FIG. 9A.

FIG. 10A is an end view of an impeller.

FIG. 10B is an end view of an impeller according to a ninth embodiment of the present invention.

FIG. 10C is a cross-sectional view of a rotor assembly including the impeller of FIG. 10B.

FIG. 11A is a perspective view of a rotor assembly according to a tenth embodiment of the present invention.

FIG. 11B is a cross-sectional view of the rotor assembly of FIG. 11A taken along section line 11B-11B in FIG. 11A.

FIG. 12A is a perspective view of a rotor assembly according to an eleventh embodiment of the present invention.

FIG. 12B is a cross-sectional view of the rotor assembly of FIG. 12A taken along section line 12B-12B in FIG. 12A.

FIG. 13A is an exploded view of a rotor assembly according to a twelfth embodiment of the present invention.

FIG. 13B is a cross-sectional view of the rotor assembly of FIG. 13A taken along section line 13B-13B in FIG. 13A.

FIG. 14A is an exploded view of a rotor assembly according to a thirteenth embodiment of the present invention.

FIG. 14B is a cross-sectional view of the rotor assembly of FIG. 14A taken along section line 14B-14B in FIG. 14A.

FIG. 15A is an exploded view of a rotor assembly according to a fourteenth embodiment of the present invention.

FIG. 15B is a cross-sectional view of the rotor assembly of FIG. 15A taken along section line 15B-15B in FIG. 15A.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

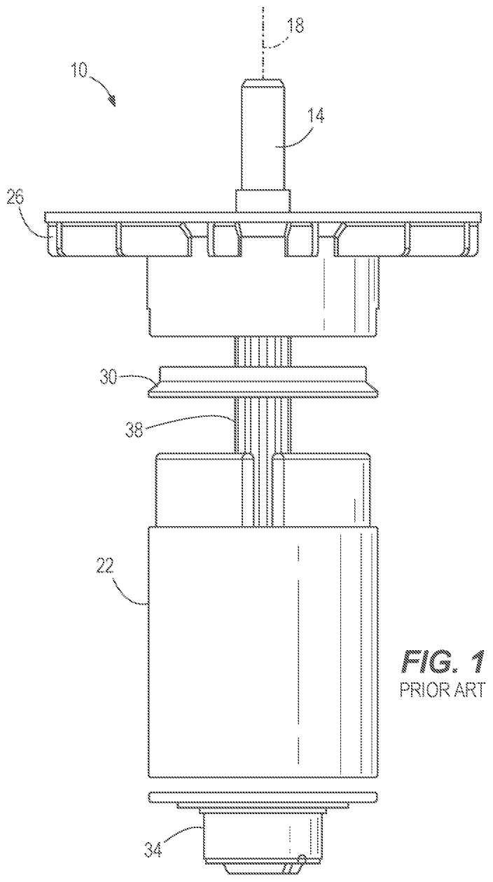

FIG. 1 illustrates an exploded view of a prior art rotor assembly 10 for an electric motor (not shown). The rotor assembly 10 is supported for rotation with respect to a stator (not shown) and includes a solid shaft 14 that extends along a longitudinal or rotational axis 18. The rotor assembly 10 also includes a lamination stack 22, a fan 26, a rubber ring 30, and a balance bushing 34. The lamination stack 22 is formed from a plurality of laminations that are stacked along the rotational axis 18. The shaft 14 is received into a central aperture (not shown) formed in the lamination stack 22. The fan 26 is coupled to the shaft 14 adjacent the lamination stack 22 so that the fan 26 rotates with the shaft 14 and provides cooling air to the electric motor. The rubber ring 30 is disposed between the fan 26 and the lamination stack 22. The balance bushing 34 is coupled to the shaft 14 adjacent the lamination stack 22 and opposite the fan 26 to rotationally balance the rotor assembly 10.

An outer surface of the shaft 14 includes knurls or splines 38 that engage the central aperture of the lamination stack 22 to rotatably fix the lamination stack 22 to the shaft 14. Moreover, the central aperture of the lamination stack 22 includes notches (not shown) that are used for orientation of parts for magnetization of magnets during the assembly process. In the prior art rotor assembly 10, imperfect knurls formed on the shaft 14 combined with the notches in the lamination stack 22 can be a source of imbalance in the rotor assembly 10. Thus, the balance bushing 34 is required to balance the rotor assembly 10.

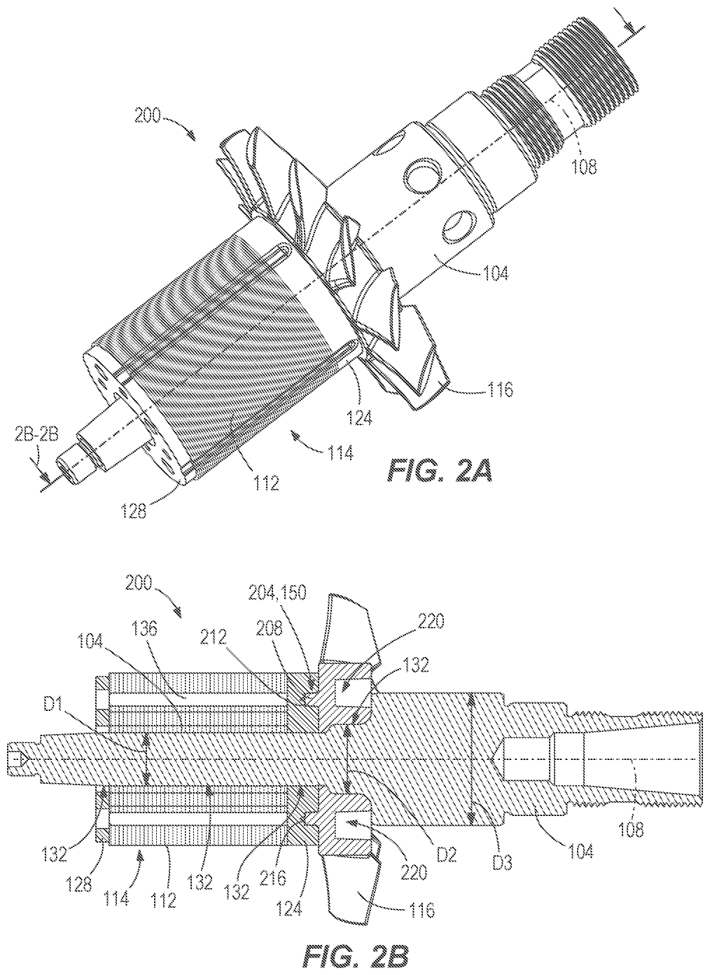

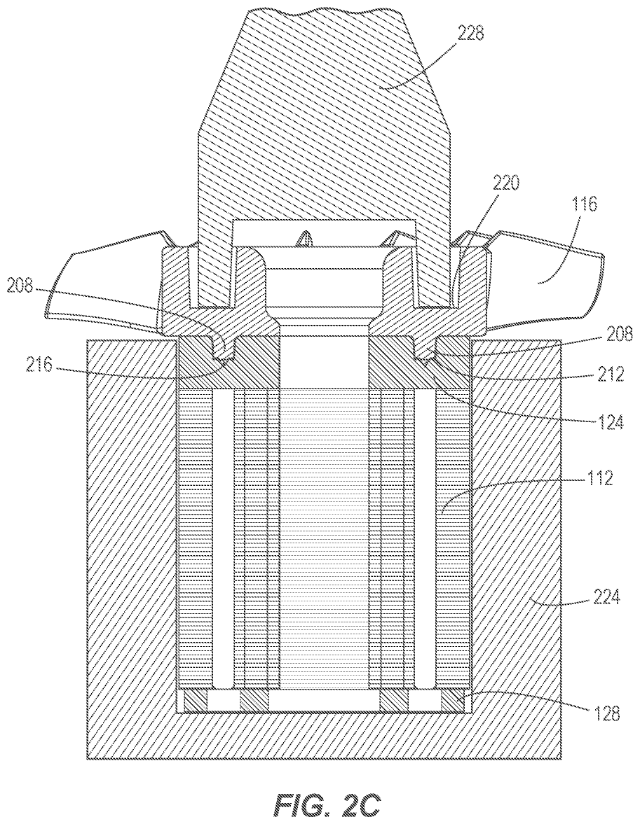

FIGS. 2A-12B illustrate various rotor assemblies 200-1500 (and portions thereof) for an electric motor (not shown) according to the present invention. The electric motor includes a stator (not shown) and one of the rotor assemblies 200-1500. The electric motor may be used in various different tools, such as power tools (e.g., rotary hammers, pipe threaders, cutting tools, etc.), outdoor tools (e.g., trimmers, pole saws, blowers, etc.), and other electrical devices (e.g., motorized devices, etc.).

The electric motor is configured as a brushless DC motor. In some embodiments, the motor may receive power from an on-board power source (e.g., a battery, not shown). The battery may include any of a number of different nominal voltages (e.g., 12V, 18V, etc.), and may be configured having any of a number of different chemistries (e.g., lithium-ion, nickel-cadmium, etc.). Alternatively, the motor may be powered by a remote power source (e.g., a household electrical outlet) through a power cord. The motor includes a substantially cylindrical stator (not shown) operable to produce a magnetic field for rotating one of the rotor assemblies 200-1500.

With reference to FIGS. 2A and 2B and the rotor assembly 200, each rotor assembly 200-1500 includes a shaft 104 extending along a longitudinal axis 108, a lamination stack 112 including a plurality of laminations, a rotor body 114, and a fan 116. The rotor body 114 and fan 116 are coupled for co-rotation with the shaft 104 about a longitudinal or rotational axis 108. As will be described in detail below, in each embodiment of the rotor assembly 200-1500, the rotor body 114 and fan 116 are coupled in different ways to the shaft 104.

As shown in FIG. 2A, the rotor body 114 includes a fan end 124 and an opposite magnet retention end 128. The fan end 124 is positioned axially adjacent to the fan 116. The magnet retention end 128 is axially spaced along the longitudinal axis 108 from the fan 116. The fan 116, fan end 124, magnet retention end 128, and lamination stack 112 each include a central aperture 132 configured to receive the shaft 104. The lamination stack 112 includes magnet slots 136 (FIG. 2B) which are configured to receive permanent magnets (not shown) which interact with the magnetic field emanated by the stator to rotate the rotor body 114 and thus the corresponding rotor assembly 200-1500.

With continued reference to FIG. 2B, the shaft 104 is a segmented shaft having different outer dimensions along the length of the shaft 104 and the longitudinal axis 108. A portion of the shaft 104 has a first outer dimension (e.g., diameter) D1, another portion of the shaft 104 has a second outer dimension (e.g., diameter) D2, and another portion of the shaft 104 has a third outer dimension (e.g., diameter) D3. In the illustrated embodiment, the second outer dimension D2 is nominally greater than the first outer dimension D1, and the third outer dimension D3 is nominally greater than the second outer dimension D2. Other unannotated segments of the shaft 104 are present, as well as transition regions between the aforementioned portions of the shaft having the first, second, and third outer dimensions D1-D3.

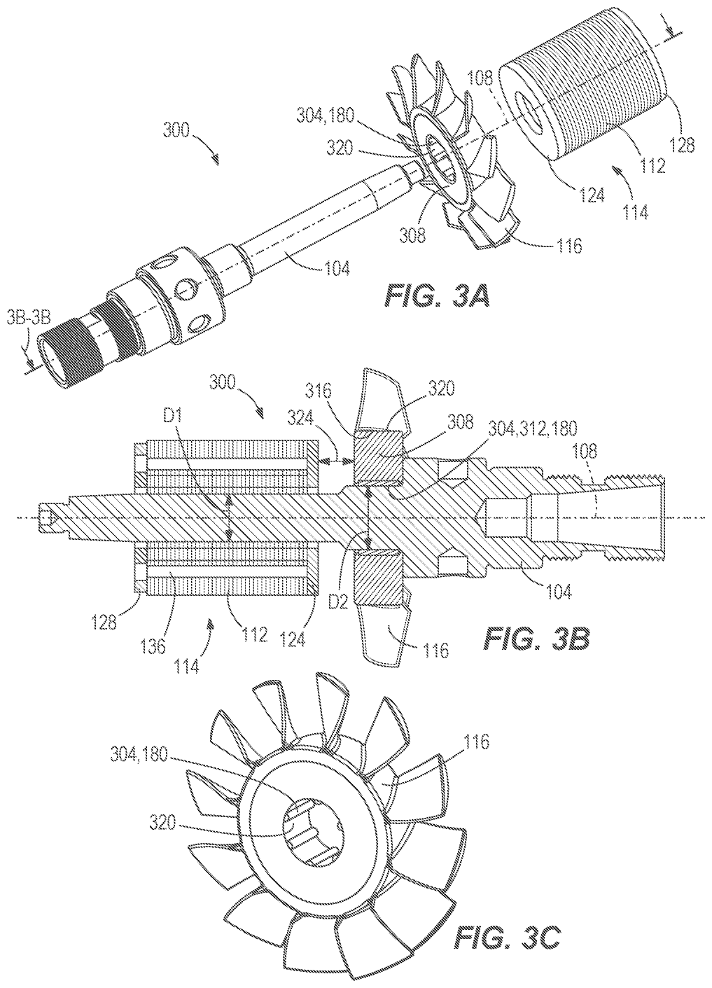

Generally speaking, two types of rotor assemblies 200-1500 are present in the instant application. A first type of rotor assembly 200-1500 includes a torque coupling 150 (e.g., rotor assemblies 200, 500, 700, 800, 1300, 1400, 1500; FIGS. 2A-2C, 5A-5D, 7A-7E, 8A-8B, 13A-13B, 14A-14B, and 15A-15B) which couples the fan 116 to the rotor body 114. In embodiments including the torque coupling 150, the rotor body 114 is coupled to the shaft 104 such that the fan 116 is indirectly connected to the shaft 104. A second type of rotor assembly 200-1500 includes a torque coupling 180 (e.g., rotor assemblies 300, 400, 600, 900, 1000, 1100, 1200; FIGS. 3A-3C, 4A-4C, 6A-6B, 9A-9C, 10A-10C, 11A-11B, 12A-12B) that couples the fan 116 (directly or indirectly) to the shaft 104. In this second type of rotor assembly 200-1500, the rotor body 114 is also separately directly connected to the shaft 104. Various mechanical structures for forming the aforementioned torque coupling 150 and torque coupling 180 differ in the described rotor assemblies 200-1500 as described below. Each type of torque coupling 150, 180 provides means of transmitting torque from the shaft 104 to the fan 116. Various other mechanical structures may replace the following torque couplings 150 and torque couplings 180.

The first rotor assembly 200 is illustrated in FIGS. 2A-2B. The first rotor assembly 200 includes a torque coupling 150 which secures the fan 116 to the rotor body 114. The torque coupling 150 is formed by an ultrasonic weld 204 between the fan 116 and the fan end 124 of the rotor body 114. The fan 116 in the first rotor assembly 200 includes a protrusion 208 which extends axially from an axial end surface of the fan 116 along the longitudinal axis 108 towards the fan end 124 of the rotor body 114. The fan end 124 includes a receptacle 212 which extends axially along the longitudinal axis towards the magnet retention end 128. The protrusion 208 and receptacle 212 may include a draft angle extending near parallel to but offset from parallel relative to the longitudinal axis 108. The draft angle may be between 3 degrees and 5 degrees. The draft angle may promote strong mechanical connection of the ultrasonic weld 204 In the illustrated embodiment, the receptacle 212 includes a pointed tip 216. In other embodiments, the protrusion 208 may include the tip 216. The fan 116 further includes, axially opposite the protrusion 208, a blind bore 220. In some embodiments, a plurality of blind bores 220 are positioned opposite each of the protrusions 208. In the illustrated embodiment, two sets of protrusions 208 and receptacles 212 are visible. However, in other embodiments, one protrusion 208 and receptacle 212 (e.g., both being generally annularly shaped about the longitudinal axis 108), or more than two sets of protrusions and receptacles (e.g., three sets of protrusions and receptacles 212) may be present. In any such embodiment, the corresponding sets of protrusions 208 and receptacles 212 may be evenly circumferentially spaced (e.g., every 120 degrees, 90 degrees, etc.) about the longitudinal axis 108 as viewed perpendicularly from the longitudinal axis 108.

During construction of the first rotor assembly 200, as illustrated in FIG. 2C, the rotor body 114 is held in a fixture structure 224. The fan 116 is loosely positioned in relation to the rotor body 114 with the protrusions 208 (e.g., tongues) positioned within the receptacles 212 (e.g., grooves). Optionally, the fixture structure 224 applies pressure to secure (i.e., temporarily clamp) the fan 116 to the rotor body 114. An ultrasonic weld horn 228 is positioned in or adjacent to the blind bore 220. High frequency mechanical vibrations are applied to the weld horn 228 by a transformer (not shown), and the weld horn 228 transmits the high frequency mechanical vibrations to the interface between the rotor body 114 and fan 116 via the protrusions 208 and receptacles 212. Vibrations cause local friction, shear force, heat, and plastic deformation between the protrusions 208 and receptacles 212, which, when cooled, form the resultant ultrasonic weld 204 and torque coupling 150. While the vibrations of the weld horn 228 are applied, the tip 216 directs the energy of the vibrations to form the ultrasonic weld 204. The rotor body 114 and fan 116 can then be removed from the fixture structure 224. As shown in FIG. 2B, the resultant rotor body 114 and fan 116 is press-fit onto the shaft 104. At least one of the central apertures 132 of the magnet retention end 128, the lamination stack 112, the fan end 124, and the fan 116 is dimensioned to form an interference fit with the outer surface (e.g., the first dimension D1 or the second dimension D2) of the shaft 104. In construction of the rotor assembly 200, the rotor body 114 and fan 116 are pressed into axially along the shaft 104. In the illustrated embodiment, the portion of the shaft 104 having the second outer dimension D2 is axially aligned with the fan 116 when the rotor body 114 and fan 116 are fully pressed (e.g., seated) into the shaft 104. More specifically, the portion of the shaft 104 having the second outer dimension D2 is axially aligned with the blind bore 220 of the fan 116.

A second rotor assembly 300 is illustrated in FIGS. 3A-3C. The second rotor assembly 300 includes a torque coupling 180 including an adhesive 304 and a bushing 308. The bushing 308 includes an inner surface 312 which engages an outer surface of the shaft 104. The adhesive 304 is positioned between the inner surface 312 of the bushing 308 and the outer surface of the shaft 104. The bushing 308 further includes an outer surface 316 which faces radially away from the shaft 104 and the longitudinal axis 108. The fan 116 has an inner surface 320 which faces radially inwardly towards the longitudinal axis 108. The inner surface 320 of the fan 116 engages the outer surface 316 of the bushing 308 by another mechanical securing mechanism (e.g., press fit, another adhesive).

During construction of the second rotor assembly 300, the fan 116 is coupled to the shaft 104 via the adhesive 304 and the bushing 308 which function as the torque coupling 180. At some point during construction, the fan 116 is pressed into axial alignment (e.g., in a left-to-right direction as viewed in FIG. 3B) with the bushing 308 to align the outer surface 316 of the bushing 308 with the inner surface 320 of the fan 116. The adhesive 304 may then cure to secure the bushing 308 with the shaft 104. At some point during construction, the fan 116 is secured to the bushing 308. This may be done before, simultaneous with, or after locating the bushing 308 on the shaft 104. In the illustrated embodiment, after pressing the bushing 308 onto the shaft 104, the rotor body 114 is pressed axially along the longitudinal axis 108 into position on the shaft 104. However, in other embodiments, the order may differ. In the illustrated embodiment of FIG. 3B, the rotor body 114 is axially spaced from the fan 116 and the bushing 308 by a gap 324. However, in other embodiments, the rotor body 114 may be pressed further in a left-to-right direction as viewed in FIG. 3B to take up the gap 324 and be axially adjacent to the fan 116 and the bushing 308.

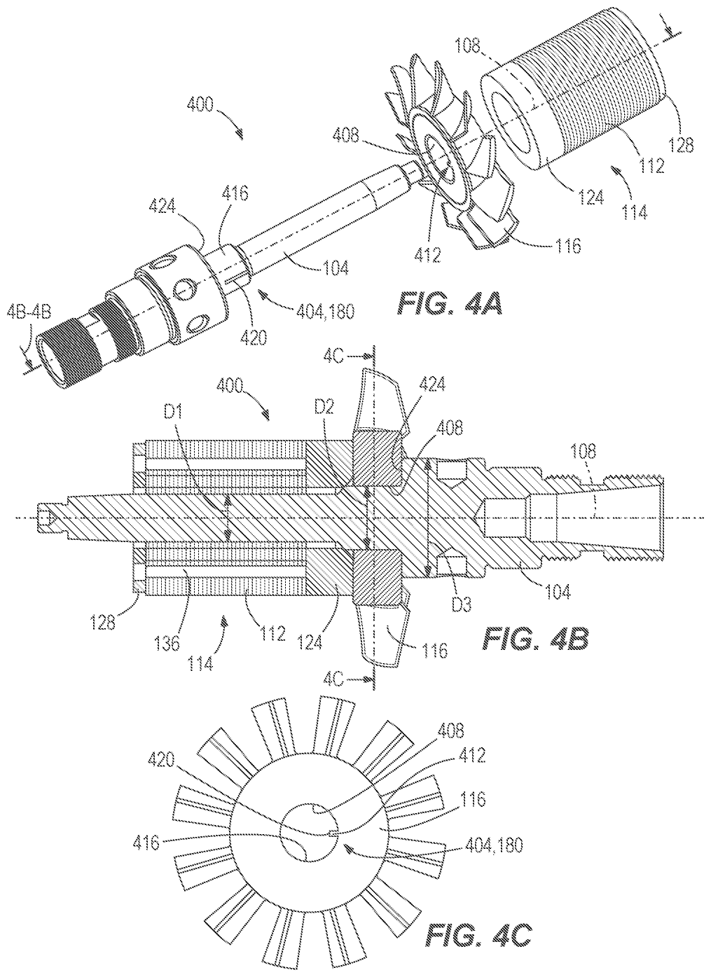

A third rotor assembly 400 is illustrated in FIGS. 4A-4C. The third rotor assembly 400 includes a torque coupling 180 in the form of an axially extending trapped key and keyway structure 404. In the illustrated embodiment (FIG. 4A), the fan 116 includes an inner surface 408 which includes a key 412. An outer surface 416 of the shaft 104 includes a keyway 420. However, in other embodiments, this arrangement may be reversed with the key 412 being present on the outer surface 416 of the shaft 104, and the keyway 420 being present on the inner surface 408 of the fan 116. The key 412 and keyway 420 are dimensioned with compatible cross-sectional profiles such that the key 412 may engage the keyway 420. In the illustrated embodiment, as illustrated in FIG. 4C, the key 412 and keyway 420 are each generally rectangular in shape. In other embodiments, the key 412 and keyway 420 may have different cross-sectional shapes from one another. In still other embodiments, either or both of the key 412 and the keyway 420 may have cross-sectional shapes which are not rectangular. In the illustrated embodiment, there is only one key 412, and only one keyway 420 (e.g., one set including one key 412 and one keyway 420). However, in other embodiments, two or more sets of keys 412 and keyways 420 may be provided. In embodiments including multiple sets of keys 412 and keyways 420, the keys 412 and keyways 420 may be circumferentially spaced about the longitudinal axis 108 in any manner. For example, the keys 412 and keyways 420 may be evenly circumferentially spaced (e.g., every 90 degrees, every 120 degrees, etc.) about the longitudinal axis 108. Such spacing may promote even load bearing/transmission between each of the sets of keys 412 and keyways 420.

During construction of the third rotor assembly 400, the fan 116 is pressed onto the shaft 104. The inner surface 408 of the fan 116 may slip along the shaft 104 with ease until reaching a portion of the shaft 104 having the second outer dimension D2. At this point, the fan 116 must be rotated about the longitudinal axis 108 to radially align the key 412 with the keyway 420. Once alignment is achieved, the fan 116 can be further pressed (in a left-to-right direction as viewed in FIG. 4B) until the fan 116 abuts a shoulder 424 of the shaft 104 at a transition between the second outer dimension D2 and the third outer dimension D3. Once or simultaneously with the axial movement of the fan 16 in the left-to-right direction along the shaft 104 as viewed in FIG. 4B, the rotor body 114 is pressed onto the shaft 104. At least one of the central aperture 132 of the lamination stack 112, fan end 124, and the magnet retention end 128 is pressed axially along the longitudinal axis 108 to position the rotor body 114 on the shaft 104.

The fan end 124 of the rotor body 114 and the shoulder 424 of the shaft 104 retain axial position of the fan 116 with the key 412 engaging the keyway 420. The keyway structure 404 transmits torque of the shaft 104 to the fan 116 to couple the fan 116 for corotation with the shaft 104.

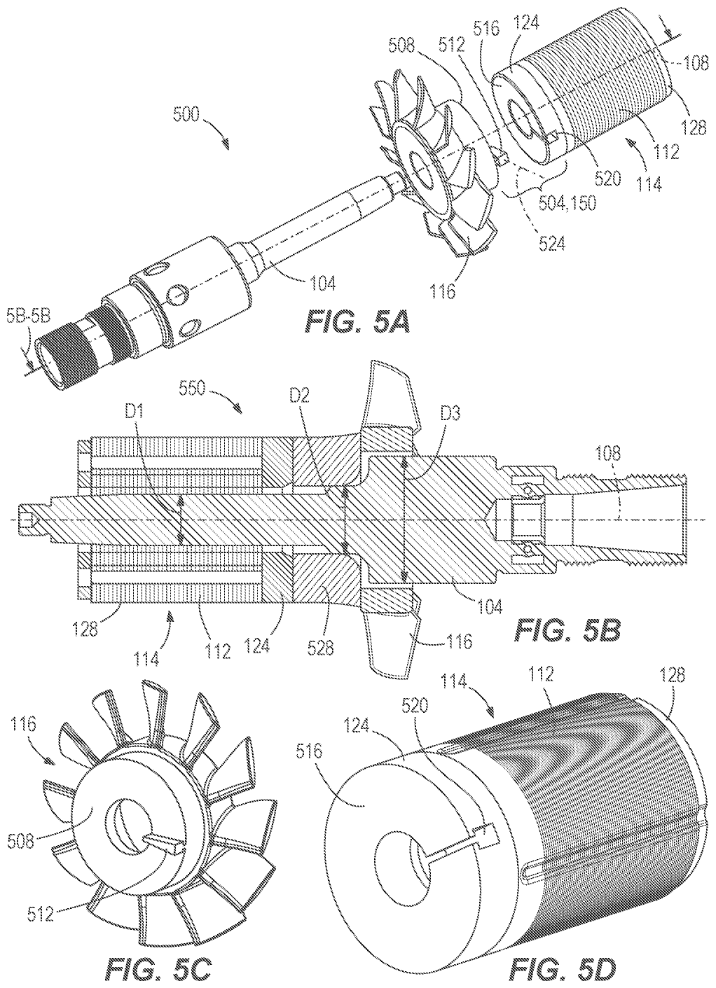

A fourth rotor assembly 500 is illustrated in FIGS. 5A, 5C, and 5D. The fourth rotor assembly 500 includes a torque coupling 150 in the form of a radially extending locked key and keyway structure 504. In the illustrated embodiment (FIG. 5A), the fan 116 includes an axial end surface 508 which includes a key 512. The key 512 extends radially with respect to the longitudinal axis 108. The fan end 124 of the rotor body 114 further includes an axial end surface 516 which includes a keyway 520. The keyway 520 extends radially with respect to the longitudinal axis 108. In other embodiments, this arrangement may be reversed with the key 512 being present on the end surface 516 of the fan end 124, and the keyway 520 being present on the end surface 508 of the fan 116. The key 512 and keyway 520 are dimensioned with compatible cross-sectional profiles (as viewed looking radially toward the longitudinal axis 108) such that the key 512 may engage the keyway 520. In the illustrated embodiment, as illustrated in FIGS. 5C and 5D, the key 512 and keyway 520 each include a shank and a main body which is generally rectangular in shape. In the illustrated embodiment, the shank of the key 512 and keyway 520 is also generally rectangular in shape. In other embodiments, the shank, main body, or both the shank and main body of the key 512 and keyway 520 may have different cross-sectional shapes from one another. In still other embodiments, either or both of the shank and main body of the key 512 and the keyway 520 may have cross-sectional shapes which are not rectangular. In the illustrated embodiment, there is only one key 512, and only one keyway 520 (e.g., one set including one key 512 and one keyway 520). However, in other embodiments, two or more sets of keys 512 and keyways 520 may be provided. In embodiments including multiple sets of keys 512 and keyways 520, the keys 512 and keyways 520 may be circumferentially spaced about the longitudinal axis 108 in any manner which permits connection of the fan 116 to the rotor body 114. For example, the keys 512 and keyways 520 may be evenly circumferentially spaced (e.g., every 180 degrees) about the longitudinal axis 108. Such spacing may promote even load bearing/transmission between each of the sets of keys 512 and keyways 520.

During construction of the fourth rotor assembly 500, the fan 116 is coupled to the rotor body 114 by sliding the keyway structure 504 into engagement, and the rotor body 114 is pressed onto the shaft 104. During engagement of the keyway structure 504, the fan 116 may be slid along a key axis 524 such that the key 512 fits within the keyway 520. Other relative movements of the fan 116 and rotor body 114 are possible. The key axis 524 in the illustrated embodiment is generally perpendicular to (e.g., in a radial direction) the longitudinal axis 108. Depending on the arrangement and geometries of the aforementioned sets of keys 5121 and keyways 520, the key axis 524 may differ.

FIG. 5B illustrates an alternate fourth rotor assembly 550 including a spacer 528. The spacer 528 may include similar key and keyway structures 504 (not shown) on either axial end thereof to engage both the fan 116 and the rotor body 114. During construction of the fourth rotor assembly 500 including the spacer 528, the fan 116, rotor body 114, and spacer 528 may be secured to one another in any order. The resultant spacer 528, fan 116, and rotor body 114 is pressed onto the shaft 104 with the rotor body 114 being coupled to the shaft 104.

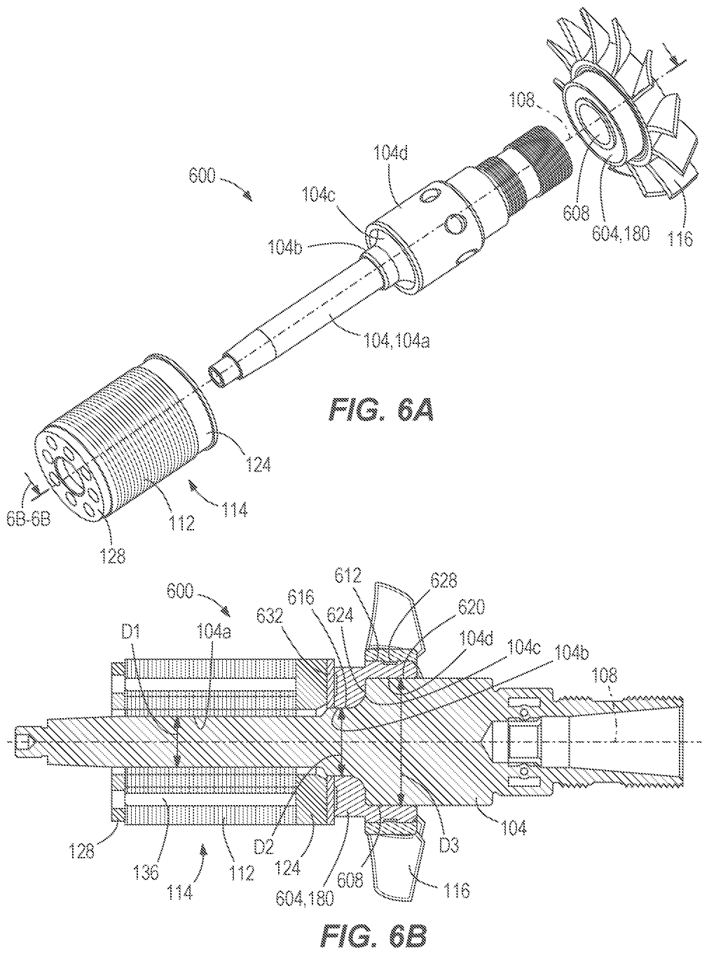

A fifth rotor assembly 600 is illustrated in FIGS. 6A-6B. The fifth rotor assembly 600 includes a torque coupling 180 in the form of a bushing 604. In the illustrated embodiment, the bushing 604 is a stepped bushing. However, in other embodiments, the bushing 604 need not necessarily include steps. The bushing 604 includes an inner surface 608 and an outer surface 612. The inner surface 608 of the bushing includes a first portion (i.e., a reduced diameter portion) 616, a second portion 620 (i.e., an enlarged diameter portion), and a transition portion 624 between the first portion 616 and the second portion 620. The outer surface 612 is generally planar. The bushing 604 is generally annular in shape, and is aligned with the longitudinal axis 108. The first portion 616 of the inner surface 608 is closer to the longitudinal axis 108 than the second portion 620 of the inner surface 608. In other words, the first portion 616 has a central aperture which is smaller in size than the second portion 620. In the illustrated embodiment, the transition portion 624 is rounded. The fan 116 has an inner surface 628 configured to engage the outer surface 612 of the bushing 604. The fan 116 may be press fit, snap-fit, or otherwise coupled to the bushing 604. The fifth rotor assembly 600 further includes a spacer 632. The spacer 632 is positioned axially between the fan end 124 of the rotor body 114 and the bushing 604.

As viewed in FIG. 6B, the shaft 104 includes a plurality of different portions 104a-104d. A first portion 104a of the shaft 104 has a relatively small size (e.g., diameter) corresponding with the first dimension D1. A second portion 104b (i.e., a reduced diameter portion) of the shaft 104 has a size (e.g., diameter) corresponding with the second dimension D2 which is greater than the first dimension D1. A fourth portion 104d (i.e., an enlarged diameter portion) of the shaft 104 has a size (e.g., diameter) corresponding with the third dimension D3 which is greater than the second dimension D2. The third portion 104c varies in size (e.g., diameter) along the longitudinal axis 108 between the second portion 104b and the fourth portion 104d to form a shoulder on the shaft 104.

During construction of the fifth rotor assembly 600, the fan 116 is coupled to the stepped bushing 604, and the stepped bushing 604 is press fit onto the shaft 104. The stepped bushing 604 is press fit in a left-to-right direction as viewed in FIG. 6B until the transition portion 624 of the stepped bushing 604 presses against the third portion 104c of the shaft 104. The spacer 632 and the rotor body 114 can then be pressed into position with the rotor body 114 being press fit to the first portion 104a of the shaft 104.

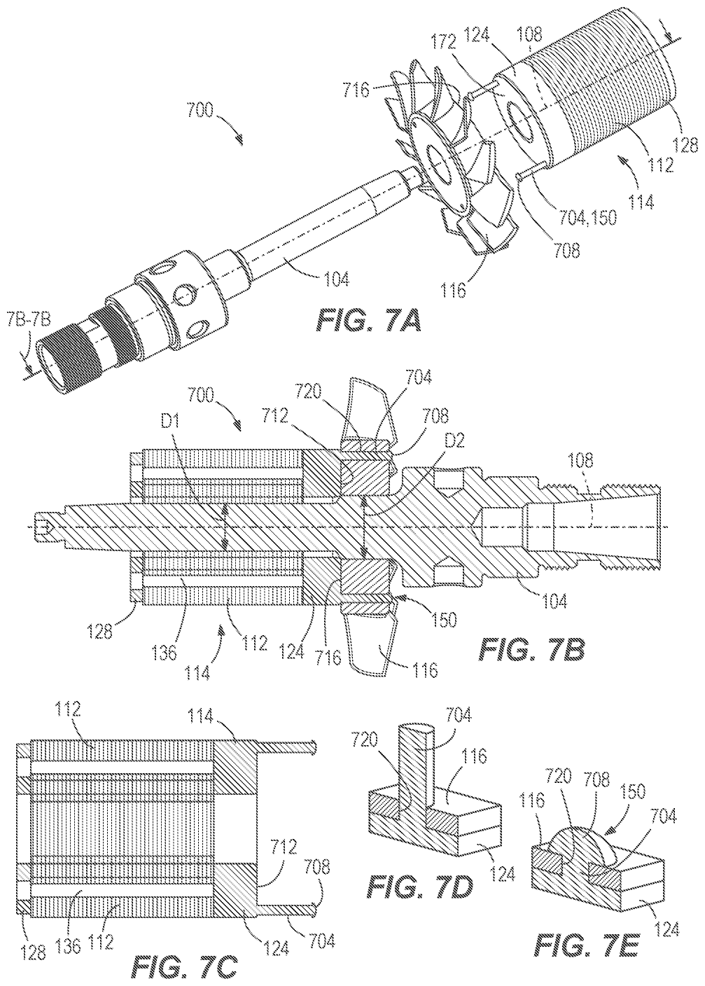

A sixth rotor assembly 700 is illustrated in FIGS. 7A-7E. The sixth rotor assembly 700 includes a torque coupling 150 in the form of a heat-staked pin 704. After heat staking, the heat-staked pin 704 includes a head 708. The pin 704 extends from an axial end surface 712 of the fan end 124 of the rotor body 114. The fan 116 includes an axial end surface 716 which faces the fan end 124 of the rotor body 114. The axial end surface 716 of the fan 116 includes a hole 720 which is configured to receive the pin 704. In the illustrated embodiment, two heat-staked pins 704 are present which diametrically oppose one another about the longitudinal axis 108. The pins 704 in the illustrated embodiment extend generally parallel with the longitudinal axis 108. Other embodiments may include different numbers, configuration (e.g., spacing with respect to the longitudinal axis 108), and/or orientations relative to the longitudinal axis 108.

During construction of the sixth rotor assembly 700, the fan 116 is coupled to the rotor body 114 by the heat-staked pin 704, and the rotor body 114 is coupled to the shaft 104 by a press fit. At some point during construction of the sixth rotor assembly 700, the pins 704 pass through the holes 720 of the fan 116. Once the pins 704 pass through the holes 720 (FIG. 7D), heat is applied to the pins 704 to melt (e.g., plastically deform) distal ends of the pins 704 into the heads 708 (FIG. 7E). The heads 708 are enlarged relative to the pins 704 to secure the fan 116 between the heads 708 and the fan end 124 of the rotor body 114.

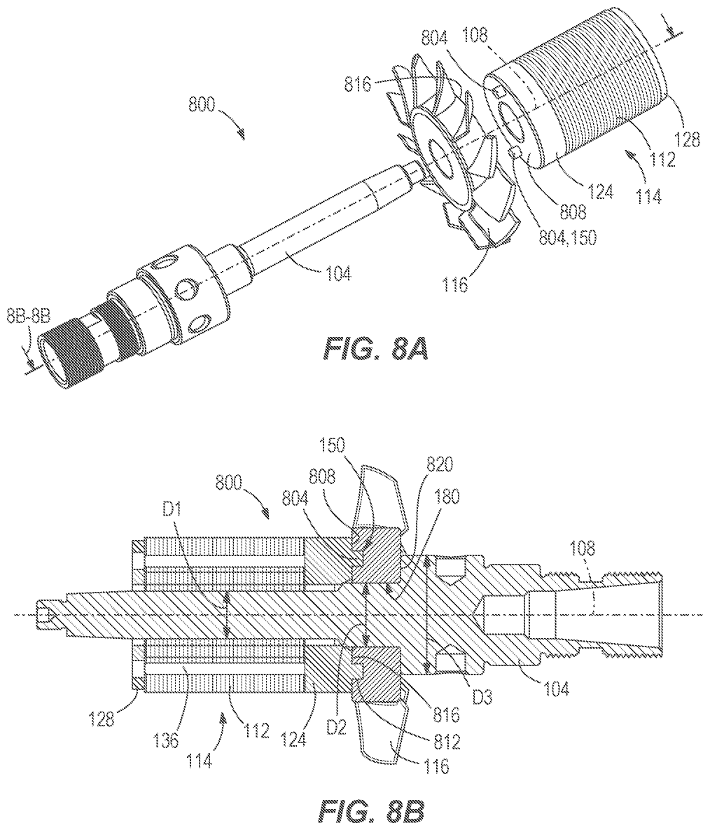

A seventh rotor assembly 800 is illustrated in FIGS. 8A-8B. The seventh rotor assembly 800 includes a torque coupling 150 in the form of a press-fit pin 804. The press-fit pin 804 extends from a first axial end surface 808 of the fan end 124 of the rotor body 114. The press-fit pin 804 is dimensioned to be press fit in a corresponding pin receptacle 812 in an axial end surface 816 of the fan 116. In the illustrated embodiment, two press-fit pins 804 extend in a direction axially parallel to the longitudinal axis 108. The pins 804 of the illustrated embodiment are diametrically opposed with respect to the longitudinal axis 108, and are dimensioned to engage two corresponding receptacles 812. In other embodiments, other quantities (e.g., one, three, or more than three) of press-fit pins 804 and receptacles 812 may be present in any orientation and/or circumferential spacing about the longitudinal axis 108. The fan 116 includes a second axial end surface 820 opposite the first axial end surface 808. The fan 116 further includes an annular inner surface 824 which spans the first axial end surface 808 and the second axial end surface 820.

During construction of the seventh rotor assembly 800, the pin 804 is press-fit to the receptacle 812 to secure the fan 116 to the rotor body 114. Optionally, the inner surface 824 of the fan 116 is press fit to the portion of the shaft 104 having the second outer dimension D2 (FIG. 8B). In such an embodiment, the press fit between the inner surface 824 of the fan 116 and the shaft 104 functions as a torque coupling 180. At some point during construction of the seventh rotor assembly 800, the second axial end surface 820 presses against a shoulder of the shaft 104 at the interface between the second outer dimension D2 and the third outer dimension D3.

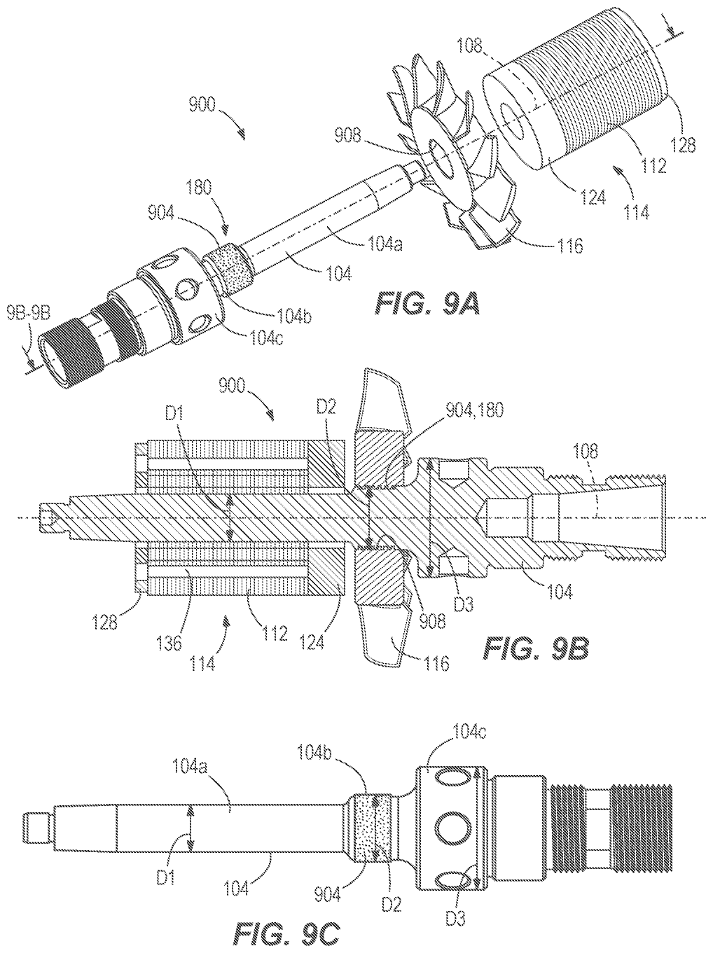

An eighth rotor assembly 900 is illustrated in FIGS. 9A-9C. The eighth rotor assembly 900 includes a torque coupling 180 formed by a connection between a rough surface finish portion 904 of the shaft 104 and a molded radial inner surface 908 of the fan 116. The rough surface finish portion 904 may be knurled, grinded, include a plurality of projections, be sanded, milled, lapped, casted, laser cut etc. The rough surface finish portion may have a relatively high average roughness value—a numerical value (e.g., measured by a contact or non-contact profilometer or the like) representing calculated average between peaks and valleys of the surface of the shaft 104. As illustrated in FIG. 9B, mold material of the molded radial inner surface 908 is deposited between the peaks and valleys of the rough surface finish portion 904 to provide a large amount of surface area contact and thus strength of the molded joint between the molded radial inner surface 908 and the rough surface finish portion 904 of the shaft 104.

During construction of the eighth rotor assembly 900, the shaft 104 is formed with the rough surface finish portion 904, and the fan 116 is molded onto the rough surface finish portion 904 with the molded radial inner surface 908 of the fan 116 engaging the rough surface finish portion 904 of the shaft 104. Before, simultaneously, or after molding the fan 116 to the rough surface finish portion 904, the rotor body 114 is pressed into engagement with the shaft 104. In the illustrated embodiment, the rotor body 114 does not contact or interfere with the rough surface finish portion 904 as it is pressed into position on the shaft 104.

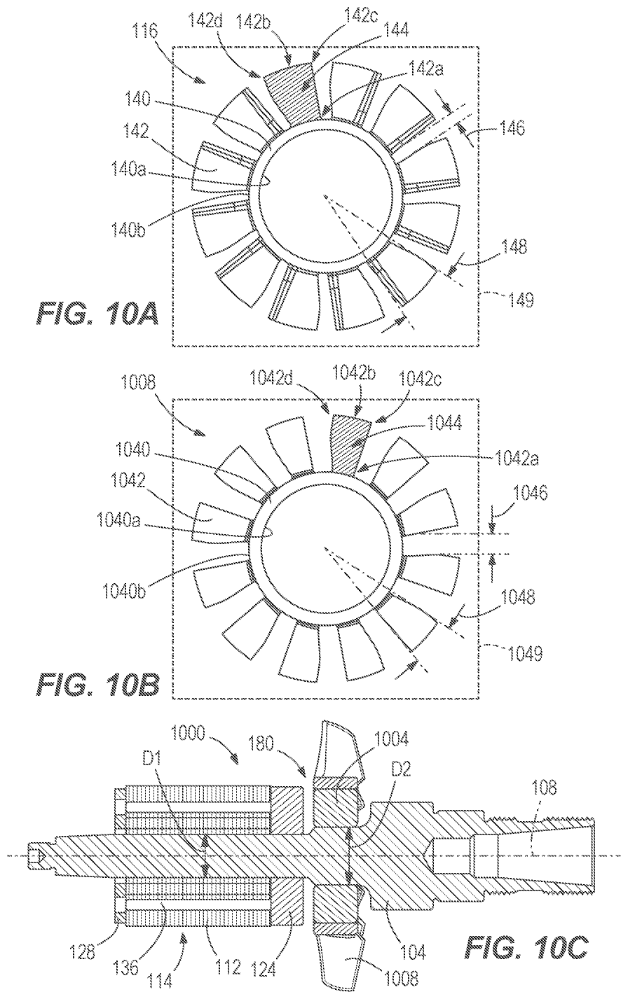

The fan 116 of the aforementioned rotor assemblies 200-900 is illustrated in FIG. 10A. The fan 116 includes a generally annular fan body 140 having a radially inner side 140a which faces the center of the fan 116 and an opposite radially outer side 140b which faces away from the center of the fan 116. A plurality of fins 142 protrude from the outer side 140b of the fan body 140. Each fin 142 includes a proximal end 142a coupled to the outer side 140b, and a distal end 142b spaced from the outer side 140b. Each fin 142 further includes a leading edge 142c and a trailing edge 142d. In the illustrated embodiment, the fins 142 have complex three-dimensional geometry. Each fin 142 defines a fin volume 144 bounded by the proximal end 142a, the distal end 142b, the leading edge 142c, and the trailing edge 142d. As shown in the end view of FIG. 10A, a radial gap 146 is present between the leading edge 142c of one fin 142 and a trailing edge 142d of an adjacent fin 142. The size of the radial gap 146 is, in part, due to a fin central angle 148. The fin central angle 148 is measured between the leading edge 142c of one of the fins 142 at the distal end 142b thereof, a center of the fan 116, and a trailing edge 142d at the distal end 142b of the same fin 142. In the illustrated embodiment, the fin central angle 148 is approximately 20 degrees. However, the fin central angle 148 may differ. In the illustrated embodiment, the geometry of each of the fins 142 is generally similar. However, in other embodiments, the geometry of each fin 142 may differ. The fan 116 is made by injection molding plastic into a mold 149. After injection molding, the fan 116 is released from the mold 149.

A ninth rotor assembly 1000 is illustrated in FIGS. 10B-10C. The structure of the ninth rotor assembly 1000 is generally similar to the second rotor assembly 300. In the illustrated ninth rotor assembly 1000, a bushing 1004 secures a fan 1008 to the shaft 104. The bushing 1004 functions as a torque coupling 180. The bushing 1004 may be press fit or otherwise secured to the shaft 104. The fan 1008 may be press fit, secured with adhesive (e.g., similar to the adhesive 304), or otherwise secured to the bushing 1004. The fan 1008 (FIG. 10B) is dimensioned differently when compared to the fan 116 (FIG. 10A) of the second rotor assembly 300.

The fan 1008 (FIG. 10B) is shaped similarly to the fan 116. Like features between the fan 116 and the fan 1008 are annotated with “100” series reference numerals transcribed into “1000” series reference numerals. However, the fins 1042 are smaller in volume when compared to the fins 142. In other words, the fin volume 1044 of the fan 1008 is nominally less than the fin volume 144 of the fan 116. As a result, the mold 1049 which is used in manufacturing the fan 1008 takes up more volume, and the fan 1008 is easier to mold than the fan 116. Various aspects of the geometry of each of the fins 1042 may differ from the fins 142. For example, the fin central angle 1048 (e.g., an arcuate length of the fins 1042 at a distal end 1042b thereof) may be smaller (e.g., approximately 17 degrees) than the fin central angle 148, size of the radial gap 1046 may be larger than the radial gap 146, and/or differing angle of attack, thickness, etc.

During construction of the ninth rotor assembly 1000, the fan 1008 is formed in the mold 1049, released from the mold 1049, and secured to the shaft 104. Optionally, the bushing 1004 is coupled with the fan 1008 and the shaft 104. The rotor body 114 is pressed onto the shaft 104.

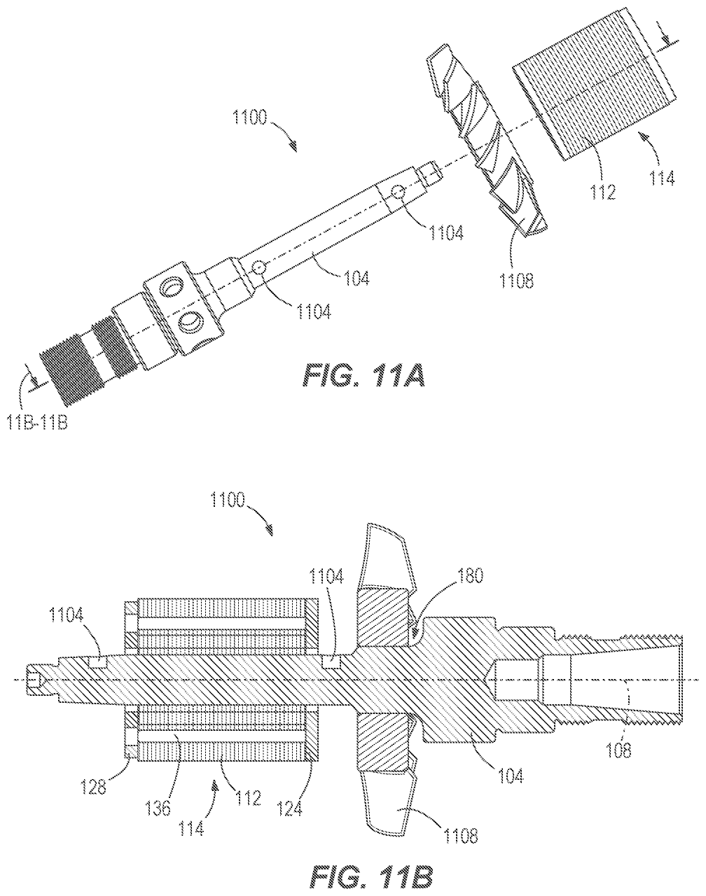

A tenth rotor assembly 1100 is illustrated in FIGS. 11A-11B. The shaft 104 of the tenth rotor assembly 1100 includes a shaft balancing feature 1104. In the illustrated embodiment, two shaft balancing features 1104 are present. The shaft balancing features 1104 of the illustrated embodiment are located on an outer surface of the shaft 104. However, in other embodiments, the shaft balancing features 1104 may be within the interior of the shaft 104. The shaft balancing features 1104 of the illustrated embodiment are recesses on the outer surface of the shaft 104. The shaft balancing features 1104 are dimensioned and positioned to counteract any off-center mass of the rotor body 114 and/or a fan 1108 of the rotor assembly 1100. In the tenth rotor assembly 1100, the fan 1108 may be pressed onto the shaft 104 such that a press-fit (e.g., interference fit) between the fan 1108 and the shaft 104 functions as a torque coupling 180 to transmit torque from the shaft 104 to the fan 1108.

During construction of the tenth rotor assembly 1100, the shaft 104 is formed with the shaft balancing feature 1104. The shaft balancing feature 1104 may be formed in any suitable manner (e.g., drilling, casing with the remainder of the shaft, etc.). In some embodiments, the shaft balancing feature 1104 may be applied to the shaft 104 after the rotor body 114 and fan 1108 are secured to the shaft 104. The fan 1108 is molded onto the outer surface of the shaft 104. The rotor body 114 is pressed onto the shaft 104 along the longitudinal axis. In the illustrated embodiment, one shaft balancing feature 1104 is positioned on each axial side of the rotor body 114 with respect to the longitudinal axis. However, in other embodiments, different shaft balancing features 1104 (e.g., protrusions) may be otherwise positioned on the shaft 104 in the assembly 1100.

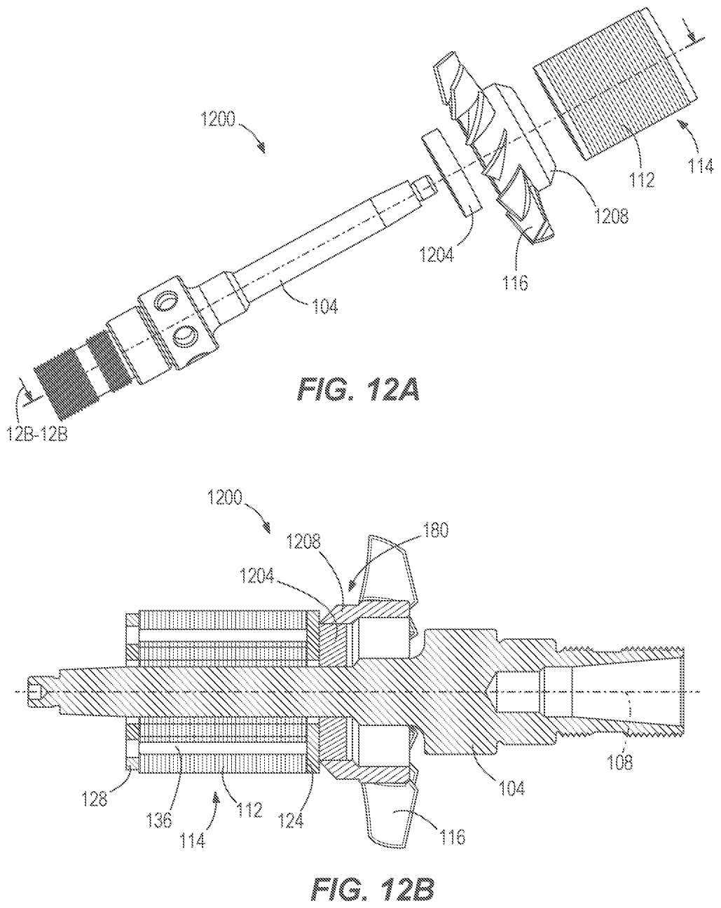

An eleventh rotor assembly 1200 is illustrated in FIGS. 12A-12B. The eleventh rotor assembly 1200 includes a bushing 1204, and the fan 116 of the eleventh rotor assembly 1200 includes a bushing engaging portion 1208. The bushing 1204 and the bushing engaging portion 1208 together form a torque coupling 180. The bushing 1204 is made of plastic for its low creep rate mechanical properties. Plastic bushings have been fount to have smaller creep rate when compared to similarly dimensioned nylon bushings. However, the bushing 1204 may comprise other low creep-rate materials other than plastic.

During construction of the eleventh rotor assembly 1200, the bushing 1204 is pressed onto the shaft 104. The fan 116 is overmolded onto the bushing 1204 with the bushing engaging portion 1208 and the bushing 1204 coupling the fan 116 for corotation with the shaft 104. Before or after the overmolding of the fan 116, the rotor body 114 is pressed onto the shaft 104.

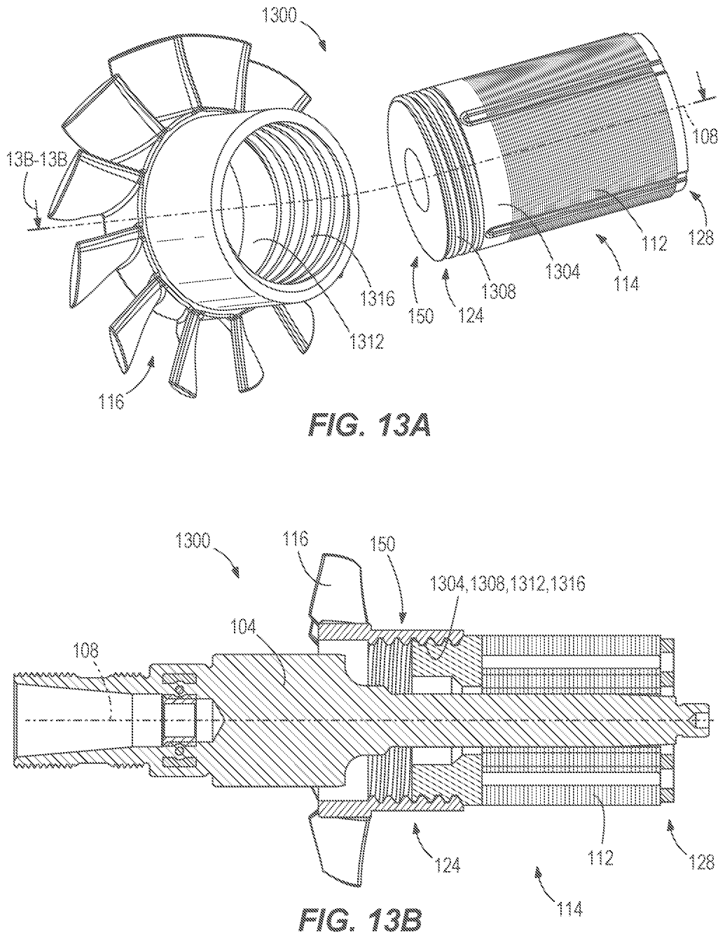

A twelfth rotor assembly 1300 is illustrated in FIGS. 13A-13B. In the twelfth rotor assembly 1300, an outer surface 1304 of the rotor body 114 includes threads 1308. The threads 1308 are positioned axially adjacent the fan end 124 of the rotor body 114. The fan 116 includes an inner surface 1312 which includes threads 1316 dimensioned to engage the threads 1308 of the rotor body 114.

During construction of the twelfth rotor assembly 1300, the fan 116 may be made separately from the rotor body 114. The shaft 104 is pressed into the rotor body 114 (e.g., the rotor body 114 itself and/or the lamination stack 112), and the fan 116 is secured to the rotor body 114 and thus the shaft 104 by a torque coupling 150 which includes the threads 1308 of the rotor body 114 and the threads 1316 of the fan 116. The shaft 104 may be pressed into the rotor body 114 before or after securing the fan 116 to the rotor body 114 via the threads 1308, 1316.

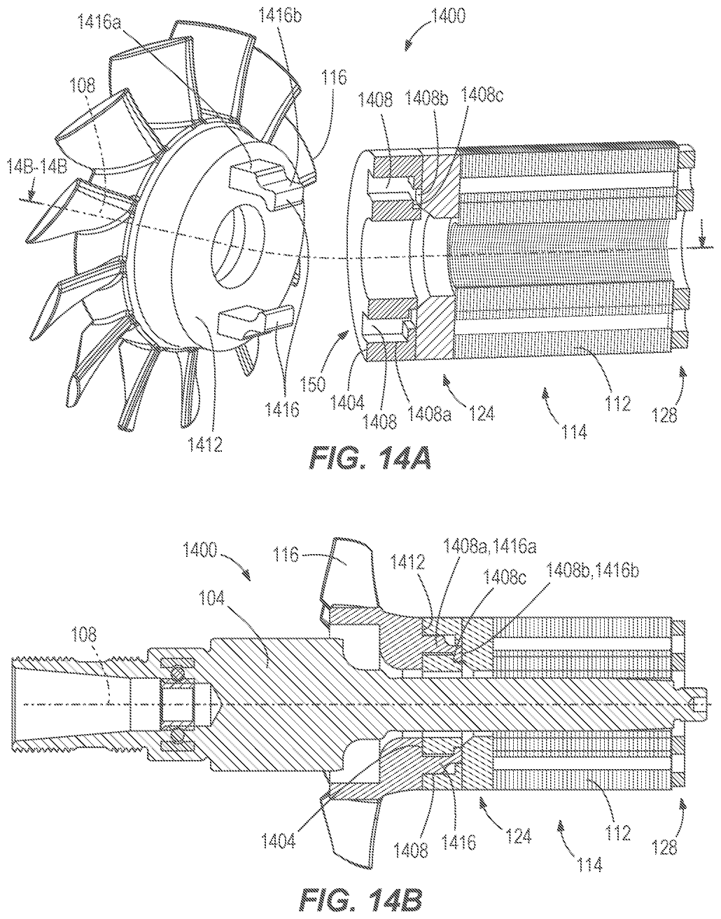

A thirteenth rotor assembly 1400 is illustrated in FIGS. 14A-14B. In the thirteenth rotor assembly 1400, an axial end surface 1404 of the rotor body 114 adjacent the fan end 124 includes a snap-fit hole 1408, and the fan 116 has an axial end surface 1412 with a snap-fit protrusion 1416. The snap-fit protrusion 1416 is dimensioned to engage the snap-fit hole 1408 to secure the fan 16 to the rotor body 114.

The snap-fit holes 1408 and snap-fit protrusions 1416 as illustrated in FIGS. 14A-14B provide one exemplary geometric assembly. Other geometries and arrangements of the snap-fit holes 1408 and snap-fit protrusions 1416 may provide similar connection between the rotor body 114 and the fan 116. In the illustrated embodiment, two snap-fit holes 1408 and two snap-fit protrusions 1416 are present. The illustrated snap-fit holes 1408 and snap-fit protrusions 1416 surround and diametrically oppose the longitudinal axis 108. In the illustrated embodiment, the snap-fit protrusions 1416 and snap-fit holes 1408 have similar geometric shapes. In the illustrated embodiment, the snap-fit protrusions 1416 and snap-fit holes 1408 each have a zig-zag cross-sectional shape (in a frame of reference perpendicular with the longitudinal axis 108) with a radially outer portion 1408a, 1416a positioned further from the longitudinal axis when compared to a radially inner portion 1408b, 1416b. The radially outer portion 1416a of the snap-fit protrusion 1416 is connected to the axial end surface 1412 of the fan 116. The radially inner portion 1416b of the snap-fit protrusion 1416 is cantilevered from the radially outer portion 1416a. The radially outer portion 1408a of the snap-fit holes 1408 are open to the fan end 124 to receive the snap-fit protrusions 1416 upon axial translation of the fan 116 along the longitudinal axis 108 towards the magnet retention end 128. The snap-fit holes 1408 define shoulder surfaces 1408c at a transition between the radially inner portions 1408a and radially outer portions 1408b thereof. After full insertion of the snap-fit protrusions 1416 into engagement with the snap-fit holes 1408, the radially inner portions 1416b of the snap-fit protrusions 1416 are held in position in the radially inner portions 1408b of the snap-fit holes 1408. The shoulder surfaces 1408c secure, in an axial direction along the longitudinal axis 108, the protrusions 1416 in this position. Different geometries of the snap-fit holes 1408 and snap-fit protrusions 1416, as well as different quantities and arrangement thereof are possible. As a non-limiting example, similar snap-fit protrusions and holes may secure radial surfaces of the fan 116 and rotor body 114 to one another. In other embodiments, the snap-fit protrusions 1416 may be formed on the rotor body 114, and the snap-fit holes 1408 may be formed on the fan 116.

During construction of the thirteenth rotor assembly 1400, the fan 116 may be made separately from the rotor body 114. The shaft 104 is pressed into the rotor body 114 (e.g., the rotor body 114 itself and/or the lamination stack 112), and the fan 116 is secured to the rotor body 114 and thus the shaft 104 by a torque coupling 150 which includes the snap-fit holes 1408 and the snap-fit protrusions 1416. The shaft 104 may be pressed into the rotor body 114 before or after securing the fan 116 to the rotor body 114 via the snap-fit holes 1408 and snap-fit protrusions 1416.

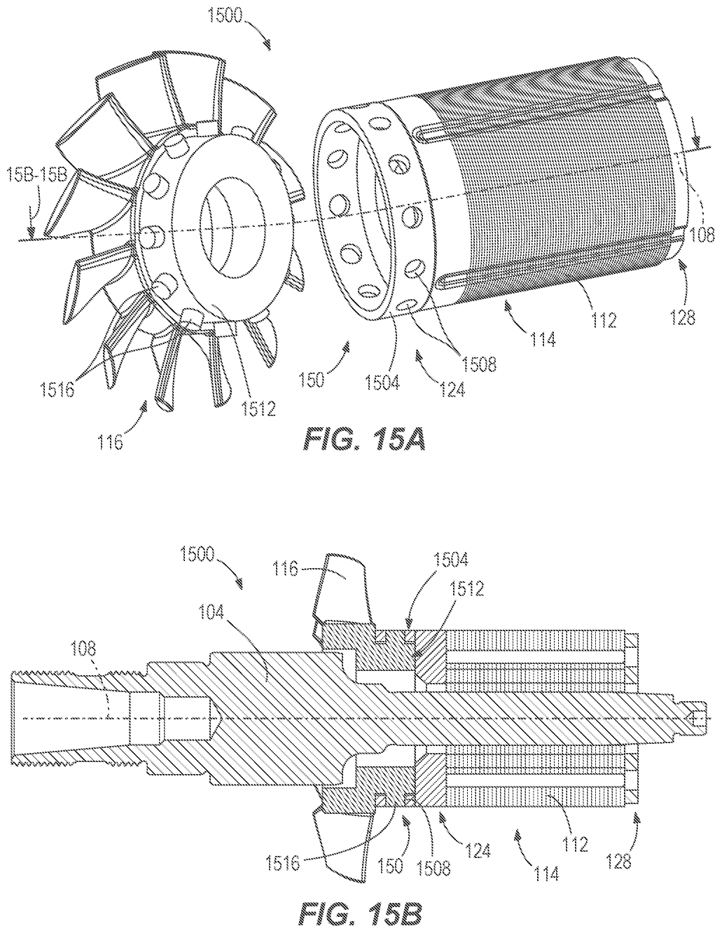

A fourteenth rotor assembly 1500 is illustrated in FIGS. 15A-15B. In the fifteenth rotor assembly 1500, the rotor body 114 is coupled to (e.g., includes) an annular ring 1504 at the fan end 124 thereof. The annular ring 1504 includes a plurality of bores 1508. The fan 116 includes a mounting ring 1512 dimensioned to fit radially within the annular ring 1504 of the rotor body 114. The mounting ring 1512 is coupled to (e.g., includes) a plurality of mating elements 1516 dimensioned in correspondence with the bores 1508. The mating elements 1516 are configured to engage the bores 1508 to secure the fan 116 to the rotor body 114. The mating elements 1516 and corresponding bores 1508

The illustrated mating elements 1516 and bores 1508 are positioned and oriented in one exemplary geometric arrangement. Other positions and orientations of mating elements 1516 and bores 1508 may provide similar connection between the rotor body 114 and the fan 116. In the illustrated embodiment, the mounting ring 1512 is dimensioned to be positioned within the annular ring 1504 and closer to the longitudinal axis 108. In other embodiments, the annular ring 1504 may be dimensioned to be within the mounting ring 1512 and closer to the longitudinal axis 108. In the illustrated embodiment, the mating elements 1516 and bores 1508 each extend in a radially outward direction relative to the longitudinal axis 108. In other embodiments, one or more of either the mating elements 1516 and bores 1508 may be oriented at any angle relative to the longitudinal axis 108. With the mounting ring 1512 positioned radially within the annular ring 1504, the mating elements 1516 are secured to the bores 1508 to transmit torque from the rotor body 114 to the fan 116. The mating elements 1516 and bores 1508 thus function as a torque coupling 150 in the rotor assembly 1500. The illustrated embodiment includes a plurality of bores 1508 and mating elements 1516 spaced evenly circumferentially about the longitudinal axis 108 in a one-to-one relationship with one another. Other quantities, spacing arrangements, and ratios of mating elements 1516 to bores 1508 are possible.

During construction of the thirteenth rotor assembly 1400, various processes may result in the aforementioned torque coupling 150 formed between the rotor body 114 and the fan 116 via the mating elements 1516 and bores 1508. The mating elements 1516 may be either integrally formed with or otherwise coupled to the mounting ring 1512. In instances where the mating elements 1516 are integrally formed with the mounting ring 1512, the annular ring 1504 may be made simultaneously with the mounting ring 1512. The annular ring 1504 may include another mechanism (e.g., mating element, protrusion, adhesive, etc.) to secure the annular ring 1504 to the fan end 124 of the rotor body 114. In instances where the mating elements 1516 are otherwise secured to the mounting ring 1512, the mounting ring 1512 may be placed axially in position along the longitudinal axis 108 at a position corresponding with the bores 1508 of the annular ring 1504. The mating elements 1516 may then be secured to the mounting ring 1512 within the bores 1508. In such embodiments, the annular ring 1504 may be integrally formed or otherwise secured with the fan end 124 of the rotor body 114. The shaft 104 may be pressed onto at least one of the rotor body 114 and the lamination stack 112 before or after securing the fan 116 to the rotor body 114. Additive manufacturing processes may also permit construction of similar bores 1508 and mating elements 1516. Other manufacturing processes and sequences may be utilized.

During operation of the motor, the stator (not shown) is energized, and the rotor assemblies 200-1500 rotate relative to the stator. Magnets of the rotor assemblies 200-1500 are acted upon by the magnetic field of the stator to cause the rotor body 114 of any given rotor assembly 200-1500 to rotate. The rotor body 114, in turn, causes rotation of the shaft 104 to operate the tool (not shown). Torque is transmitted via the above-described torque couplings 150 or the above-described torque couplings 180 to rotate the fan 116. Upon rotation of the fan 116, an airflow is generated by the fan 116. The airflow may cool the motor. The airflow may cool either or both of the stator and the corresponding rotor assembly 200-1500. In some embodiments, airflow of the fan 116 may be utilized to cool other components of the tool (e.g., heat generating switches, controllers, potting boat assemblies, etc.). The above-described rotor assemblies 200-1500 may be applied in various power tools and other motor-operated tools. As a non-limiting example, the rotor assemblies 200-1500 may be applied in blowers and/or personal cooling fans.

Although the application has been described in detail with reference to certain preferred embodiments, variations and modifications exist within the scope and spirit of one or more independent aspects of the application as described.

Various features of the disclosure are set forth in the following claims.

What is claimed is:

1. An electric motor comprising:
a stator; and
a rotor assembly at least partially received in the stator, the rotor assembly including
a rotor body including a lamination stack, the lamination stack defining a central aperture,
a fan formed separately from the rotor body, the fan being coupled to the rotor body by a torque coupling, and
a shaft including an outer surface, the shaft being pressed into the central aperture of the lamination stack with the outer surface engaged with the central aperture by an interference fit.

2. The electric motor of claim 1, wherein the torque coupling is an ultrasonic weld.

3. The electric motor of claim 1, wherein the torque coupling includes a key structure on one of the rotor body and the fan, and a keyway structure on the other of the rotor body and the fan.

4. The electric motor of claim 1, wherein one of the rotor body and the fan includes a pin, wherein the other of the rotor body and the fan includes a hole, and wherein the pin is heat-staked to the hole, thereby forming the torque coupling to secure the fan and the rotor body together.

5. The electric motor of claim 1, wherein one of the rotor body and the fan includes a pin, wherein the other of the rotor body and the fan includes a hole, and wherein the pin is configured to engage the hole by a second interference fit, the second interference fit forming the torque coupling.

6. The electric motor of claim 1, wherein rotor body and the fan each include threads, and wherein the threads of the fan are configured to engage the threads of the rotor body to form the torque coupling.

7. The electric motor of claim 1, wherein one of the rotor body and the fan includes a snap-fit protrusion and the other of the rotor body and the fan includes a snap-fit hole, and wherein the snap-fit protrusion is configured to engage the snap-fit hole by a snap-fit to form the torque coupling.

8. The electric motor of claim 1, wherein one of the rotor body and the fan includes a radially extending mating element and the other of the rotor body and the fan includes a radially extending bore, and wherein the mating element is configured to engage the bore to form the torque coupling.

9. An electric motor comprising:
a stator; and
a rotor assembly at least partially received in the stator, the rotor assembly including
a rotor body including a lamination stack, the lamination stack defining a central aperture,
a fan formed separately from the rotor body,
a shaft including an outer surface, the shaft being pressed into the central aperture of the lamination stack with the outer surface of the shaft engaged with the central aperture by an interference fit, and
a torque coupling which couples the fan to the shaft.

10. The electric motor of claim 9, wherein the torque coupling is a bushing having a bushing outer surface and a bushing inner surface, the bushing inner surface being pressed onto the outer surface of the shaft by a second interference fit, and the fan being pressed onto the outer surface of the bushing by a third interference fit.

11. The electric motor of claim 10, wherein the bushing inner surface has a reduced diameter portion and an enlarged diameter portion, the outer surface of the shaft has a reduced diameter portion and an enlarged diameter portion at different axial positions along the shaft, the reduced diameter portion of the bushing is pressed onto the reduced diameter portion of the shaft, and the enlarged diameter portion of the bushing is pressed onto the enlarged diameter portion of the shaft.

12. The electric motor of claim 9, wherein the torque coupling includes a key and keyway structure having a key on one of the fan and the shaft, and a keyway on the other of the fan and the shaft in which the key is received.

13. The electric motor of claim 9, wherein the shaft includes a rough surface finish portion on the outer surface thereof, and the fan is molded to the rough surface finish portion to form the torque coupling.

14. The electric motor of claim 9, wherein the fan is molded onto the outer surface of the shaft to form the torque coupling.

15. The electric motor of claim 9, wherein the outer surface of the shaft is generally cylindrical about a longitudinal axis, and the outer surface of the shaft includes a shaft balancing feature in the form of either a recess or a protrusion.

16. The electric motor of claim 9, wherein the torque coupling is a bushing having a bushing inner surface, the bushing inner surface being pressed onto the outer surface of the shaft by a second interference fit, and the fan being overmolded onto the bushing.

17. The electric motor of claim 16, wherein the bushing is made of plastic.

18. The electric motor of claim 9, wherein the torque coupling includes an adhesive which connects the fan to the shaft.

19. The electric motor of claim 9, wherein the outer surface of the shaft defines a shoulder between portions thereof which have different outer dimensions, and wherein the fan is configured to abut the shoulder.

20. The electric motor of claim 9, wherein the interference fit and the torque coupling separately directly connect the fan to the shaft and the rotor body to the shaft.
